(19) United States
(12) Patent Application Publication
(10) Pub. No.: US 2006/0285261 A1
(43) Pub. Date: Dec. 21, 2006

(54) Pulse adjusting protective circuit

(75) Inventors: Tyng-Cheng Lan, Guiren Shiang (TW); Cheng-Chun Chou, Fengshan City (TW); Hsin-mao Hsieh, Pingtung City (TW)

Correspondence Address: TROXELL LAW OFFICE PLLC;SUITE 1404, 5205 LEESBURG PIKE, FALLS CHURCH, VA, 22041, US

(73) Assignee: Hsin-mao HSIEH

(21) Appl. No.: 11/152,180

(22) Filed: Jun. 15, 2005

(51) Int. Cl. H02H 5/04

(52) U.S. Cl. 361/23

(57) ABSTRACT

A pulse adjusting protective circuit includes a driving circuit, a running detecting circuit and a pulse trigger circuit. When the driving circuit cannot work normally, the running detecting circuit will output signals to make the pulse trigger circuit output pulse(s) for testing motor. The period of the pulse can be adjusted to control the current flowing during driving motor. The current flowing during testing motor is less than normal operation.

### FIELD OF THE INVENTION

The present invention relates to a protective circuit when a motor is locked, more particularly to a pulse adjusting protective circuit.

### BACKGROUND OF THE INVENTION

Generally the current of locking motor must become greater than the current flowing in normal operation when a fan motor is abnormal. FIG. 1 illustrates a known current limiting protective circuit. It mainly includes a driving circuit 110 and a current limiting circuit 120. Once a trouble happens to motor and the fan blade is unable to work, the locking current makes collector voltage of transistor of current limiting circuit 120 become a low potential that disconnects the transistor of driving circuit 110 so as to decrease the current flowing in normal operation. However, while such a way to limit current occurs, mostly voltage descends at both ends of transistor to result in an extreme power against the transistor, thus a security problem is apparently concerned.

Referring to FIG. 2, a known fan protective circuit of locking motor basically comprises a driving circuit 210 and a time base generating circuit 220. When a fan motor is unable to operate normally, there is no current flowing across the driving circuit 210 for a period of transmitting high potential signals from the time base generating circuit 220. While the time base generating circuit 220 transmits low potential signals to make current begin to flow across the driving circuit 210, since the cause of locking motor is not removed yet initially, the current keeps bumping against the transistor within the driving circuit 210, and besides the current is far greater than that flowing in normal operation, the reliability of transistor is seriously concerned.

Moreover, another known circuit, which has a locking current far greater than the current flowing in normal operation, is disclosed in R.O.C. Taiwan Patent application No. 092,122,150 entitled “Brushless DC motor having a multiple speed control circuit”.

### SUMMARY

It is a primary object of the present invention to provide a pulse adjusting protective circuit when a motor is locked. A pulse trigger circuit is employed to transmit pulses to try to drive motor, wherein the period of the transmitting pulses is adjustable so as to enable the current flowing in the period of testing motor to be less than current flowing in normal operation.

It is a secondary object of the present invention to provide a pulse adjusting protective circuit. A pulse trigger circuit is utilized for transmitting pulses to try to drive motor, wherein the period of the transmitting pulses can be adjusted to make the current flowing in the period of testing motor be less than normal operation. Accordingly, it is avoidable that current surge pumps against transistor or other elements in the driving circuit while a motor is locked, thereby improving reliability of whole circuit and lessening defective fraction. Besides, since the current flowing in the period of testing motor is less than normal operation, the current flowing in normal operation can be directly used for designating circuit to increase utilization ratio of circuit elements.

In accordance with the present invention, a pulse adjusting protective circuit essentially includes a driving circuit, a running detecting circuit and a pulse trigger circuit. The driving circuit is employed to operate a motor. When the driving circuit cannot work normally, the running detecting circuit will notice the pulse trigger circuit by transmitting signals to allow the pulse trigger circuit to transmit pulses for testing motor. In addition, the period of pulses is adjustable to control the current flowing during testing motor less than normal operation.

### DESCRIPTION OF THE DRAWINGS

FIG. 1 shows a known current limiting protective circuit.

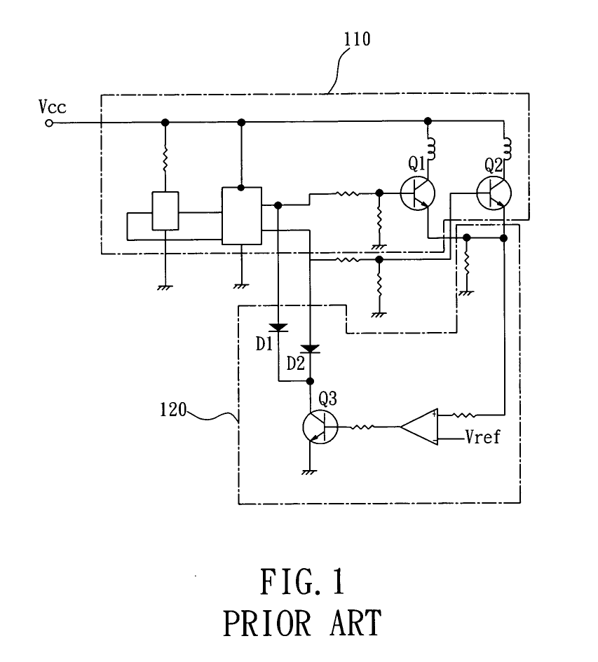

FIG. 2 shows a known protective circuit used in locking of a fan motor.

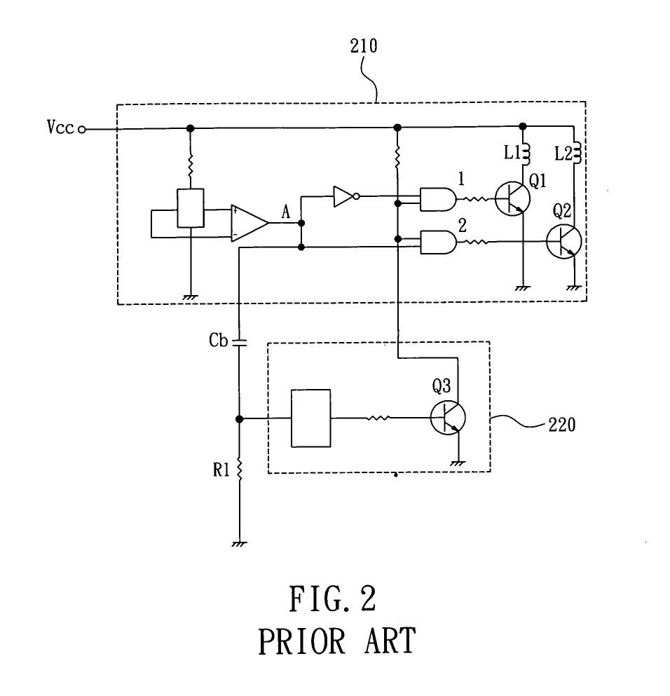

FIG. 3 shows a pulse adjusting protective circuit in accordance with the present invention.

### DETAILED DESCRIPTION OF THE PRESENT INVENTION

Referring to the drawings attached, the present invention is described by means of the embodiment below.

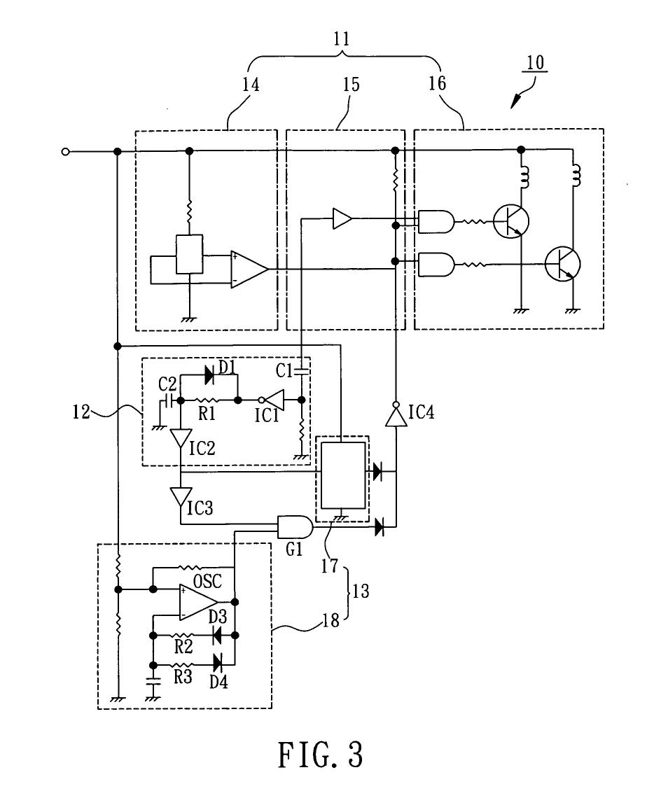

Referring to FIG. 3, a pulse adjusting protective circuit 10 includes a driving circuit 11, a running detecting circuit 12 and a pulse trigger circuit 13. The driving circuit 11 includes a hall voltage amplifier circuit 14, a phase reversing circuit 15 and a coil driving circuit 16 to be employed to operate a fan motor. In this embodiment, the running detecting circuit 12 comprises a first capacitor C1, a second capacitor C2, a first inverter IC1, a second inverter IC2 and a first diode D1. The pulse trigger circuit 13 includes an ON/OFF timing circuit 17 and a pulse generating circuit 18, wherein the ON/OFF timing circuit 17 may be replaced by a time base generating circuit or another pulse generating circuit. In this embodiment, a time base generating circuit is chosen. When the driving circuit 11 works normally, the first capacitor C1 of the running detecting circuit 12 transmits operating signals to the first inverter IC1, and then the first inverter IC1 is likely to transmit low potential signals or high potential signals. While the output signals of the first inverter IC1 are low potential signals, the electric charges of the second capacitor C2 flow into the first inverter IC1 via the first diode D1 to discharge, so that the second capacitor C2 cannot be charged to obtain a high potential. Alternatively, while the first inverter IC1 outputs high potential signals, which across the first resistor R1 directly charges the second capacitor C2. Nevertheless, since charging time of the second capacitor C2 (R1×C2) is far longer than operating frequency, the second capacity C2 is still unable to obtain a high potential. When the driving circuit 11 works normally, the running detecting circuit 12 keeps transmitting high potential signals, and the high potential signals are changed to low potential signals through a third inverter IC3 that makes the pulse trigger circuit 13 also transmit low potential signals and which are further changed to high potential signals through a fourth inverter IC4. Therefore, the coil driving circuit 16 of the driving circuit 11 won't be controlled by the pulse trigger circuit 13 substantially.

If the driving circuit 11 cannot work, the first inverter IC1 receives no signal from the first capacitor C1 of the running driving circuit 12 and then transmits high potential signals to charge the second capacitor C2 via the first resistor R1. When the second capacitor C2 reaches high potential, the second inverter IC2 transmits low potential signals, it is noted that the running driving circuit 12 transmits low potential signals to start the ON/OFF timing circuit 17. When the ON/OFF timing circuit 17 outputs high potential signals, which are further changed to low potential signals via the fourth inverter IC4, thus the coil driving circuit 16 of the driving circuit 11 won't be conducted. When the ON/OFF timing circuit 17 outputs low potential signals, which are isolated by a second diode D2. Besides, the low potential signals transmitted from the running detecting circuit 12 also pass through the third inverter IC3 and are changed to high potential signals transmitting to an AND gate G1. One input end of the AND gate G1 is connected with the pulse generating circuit 18, which is consisted of an oscillator OSC, a third capacitor C3, a third diode D3 and a fourth diode D4. The output of the oscillator OSC is regarded as output of the AND gate G1. The oscillator OSC is capable of transmitting a plurality of pulses that vary in different ON/OFF time ratio by utilizing the third capacitor C3 which has different period of charge and discharge derived from two networks of the third diode D3 connected with a second resistor R2 and the fourth diode D4 connected with a third resistor R3. When the pulse generating circuit 18 transmits low potential signals to the AND gate G1, the output of the AND gate G1 regarded as input of the fourth inverter IC4 is also low potential signals. Accordingly, when both the ON/OFF timing circuit 17 and the pulse generating circuit 18 transmit low potential signals simultaneously, the pulse trigger circuit 13 will output a plurality of pulses trying to drive motor. In addition, it is able to designate or adjust ON/OFF time ratio of pulses transmitted from the pulse generating circuit 18 so the current flowing during testing motor can be controlled without bumping against the driving transistor.

The present invention is fully applied while the driving circuit 11 cannot work normally to transmit pulses for testing motor from the pulse trigger circuit 13. Initially, the running detecting circuit 12 outputs low potential signals to start the ON/OFF timing circuit 17, and the low potential signals are inverted to high potential signals via the third inverter IC3 and transmitted to the AND gate G1. Then, the pulse generating circuit 18 transmits low potential signals. Furthermore, when the ON/OFF timing circuit 17 outputs low potential signals, the pulse trigger circuit 13 will transmit pulses trying to drive motor. The period of transmitting the pulses is adjustable to allow the current flowing during testing motor to be less than that flowing in normal operation, so it is avoidable that current surge pumps against transistor or other elements in the driving circuit while motor is locked, thereby improving reliability of whole circuit and lessening defective fraction. Besides, since the current flowing during testing motor is less than that normal operation, the current flowing in normal operation can be directly used for designating circuit to increase utilization ratio of circuit elements.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A pulse adjusting protective circuit comprising a driving circuit configured for operating motor, a running detecting circuit and a pulse trigger circuit, the running detecting circuit transmitting signals while the driving circuit cannot work normally to inform the pulse trigger circuit to transmit pulses for testing drive motor, wherein the period of transmitting pulses is adjustable to control the current flowing during testing motor.

2. The pulse adjusting protective circuit in accordance with claim 1, wherein the current flowing during driving motor is less than that flowing in normal operation.

3. The pulse adjusting protective circuit in accordance with claim 1, wherein the pulse trigger circuit includes an ON/OFF timing circuit and a pulse generating circuit.

4. The pulse adjusting protective circuit in accordance with claim 3, wherein the ON/OFF timing circuit is a time base generating circuit.

5. The pulse adjusting protective circuit in accordance with claim 3, wherein the ON/OFF timing circuit is another pulse generating circuit.

6. The pulse adjusting protective circuit in accordance with claim 1, wherein the driving circuit comprises a hall voltage amplifier circuit, a phase reversing circuit and a coil driving circuit.
